(19) United States
(12) Patent Application Publication
(10) Pub. No.: US 2010/0125994 A1
(43) Pub. Date: May 27, 2010

(54) INTERFACE CARD FIXING DEVICE

(76) Inventor: Deng-Hsi CHEN, Keelung (TW)

Correspondence Address: Muncy, Geissler, Olds & Lowe, PLLC, 4000 Legato Road, Suite 310, FAIRFAX, VA, 22033, US

(21) Appl. No.: 12/427,372

(22) Filed: Apr. 21, 2009

(30) Foreign Application Priority Data
Nov. 26, 2008 (TW) 097221188

(51) Int. Cl. B25B 27/00; B23P 19/04

(52) U.S. Cl. 29/267; 29/278

(57) ABSTRACT

An interface card fixing device that is installed within a computer case, and is provided with a plurality of sets of push rods, which an assembler can move using his hand to cause the push rods to hold down the L-shaped installation pieces of interface cards. Application of pressure to these installation pieces is used to complete quick fixation of the interface cards to corresponding positions of the interior of the computer case, and the assembler does not need to use any hand tools to complete assembly or disassembly of the interface card.

### BACKGROUND OF THE INVENTION

(a) Field of the Invention

The present invention relates to an interface card fixing device, which is installed in a computer case to enable interface cards to be effectively fixed therein, and more particularly to an interface card fixing device that enables rapid fixing or disassembling of interface cards without the need for hand tools.

(b) Description of the Prior Art

Interface cards are the communication bridges between the computer and peripheral hardware, and hardware such as the monitor, keyboard, CD-ROM (Compact Disk-Read Only Memory) drive, printer, hard disk, and so on, can only operate normally by the transmission of data through the interface cards. Present day computers have a number of built-in interfaces, and only if needed are external interfaces added. However, the development of digital information has made the built-in interfaces of the host computer inadequate to meet the needs of current use. For example, computer game players place considerable importance on the acoustic-optic effects when playing computer games. Hence, only high-end computer hardware specifications can satisfy the associated requirements, and these kinds of requirements usually need the separate assembly of high-end graphic display cards, sound effect cards, and the like. Another example is the requirements for Internet connection, which needs the additional installation of a modem card, and so on.

Referring to FIG. 1, which shows an assembly schematic view for an interface card of the prior art, and as depicted in the drawing, a plurality of sets of interface card installation holes 102 are formed at a rear end portion of a computer case 101 of a host computer 10, and a screw hole 1021 is formed in a side portion of each of the sets of interface card installation holes 102. Furthermore, when installing an interface card 103 using prior art, a L-shaped installation piece 1031 at one end of the interface card 103 is first located close to one of the sets of interface card installation holes 102, and a U-shaped groove 1032 formed in the L-shaped installation piece 1031 is made to correspond with the screw hole 1021 in the side portion of the set of interface card installation holes 102, and after a screw 104 is made to penetrate the U-shaped groove 1032, then a hand tool is used, such as a screw driver, to screw tight the screw 104 into the screw hole 1021. Fixed locking of the screw 104 is used to cause the L-shaped installation piece 1031 to be mounted tight to the side portion of the set of interface card installation holes 102, thereby accomplishing installation of the interface card 103, after which supplementary electrical connection thereof is carried out to complete the associated installation.

According to the above, although such an installation method of the prior art enables accomplishing fixation of the interface card 103, however, each time the interface card 103 needs to be disassembled, a hand tool is necessary to assist in the disassembling operation. Regardless of whether installing or disassembling, because a hand tool is required to assist in the operational procedure, thus, the entire process consumes a considerable amount of time. Furthermore, because the interface card 103 itself is a precision electronic device, and the various electronic components on the surface of the interface card 103 are exposed, thus, during the installation or disassembling process, an inadvertent application of force, or the hand tool accidentally contacting the surface of the interface card 103 could result in damage to the interface card 103.

### SUMMARY OF THE INVENTION

In light of the aforementioned problems, the inventor of the present invention, having accumulated many years of experience in the design of related products, has carried out extensive research and analysis of the conditional requirements for the use and the installation and disassembly process of an interface card with the intention of further improving the assembly structure to enable the entire assembly or disassembly process simpler and safer. Accordingly, a primary objective of the present invention is to provide an interface card fixing device that enables implementing quick installation or disassembly without the assistance of hand tools.

In order to achieve the aforementioned objective, the present invention is primarily formed from a base, a plurality of sets of push rods are assembled to the base, and a press piece is formed on an end of each of the push rods. During implementation, the entire base is first assembled close to the rear side of a computer case to effect correspondence with positions of side portions of sets of interface card installation holes. When it is required to install an interface card, the L-shaped installation piece at one end of the interface card need only be made to abut against one of the sets of interface card installation holes, and then the push rod is moved using the hand to cause the push rod to press against the L-shaped installation piece, thereby effectively fixing the interface card. When it is required to disassemble the interface card, the push rod is moved in a reverse direction to cause the press piece to separate from the interface card, thereby completing disassembly. Hence, the installation or disassembly process is completed entirely without the assistance of hand tools.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is an assembly schematic view for an interface card of the prior art.

FIG. 2 is an external elevational view of the present invention.

FIG. 3 is a sectional schematic view (1) of the present invention.

FIG. 4 is an implementation schematic view (1) of the present invention.

FIG. 5 is an implementation schematic view (2) of the present invention.

FIG. 6 is a sectional schematic view (2) of the present invention.

### DETAILED DESCRIPTION OF THE PREFERRED EMBODIMENTS

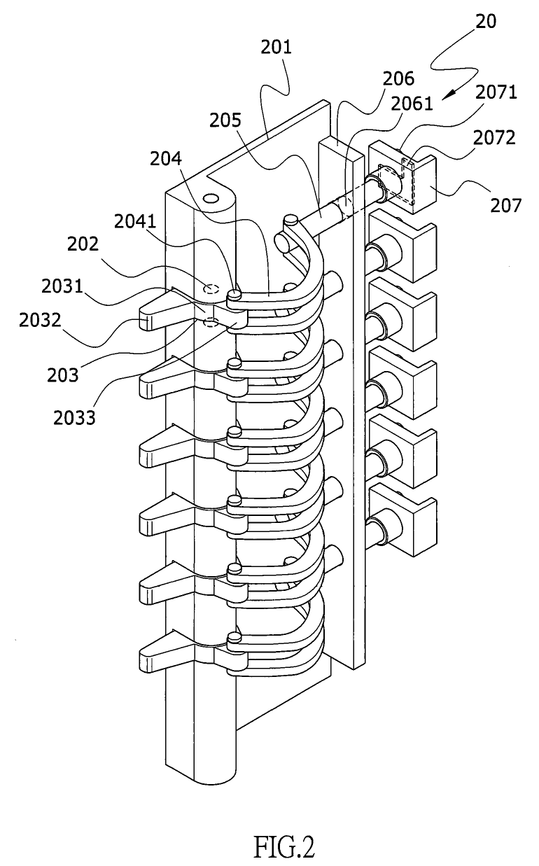

Referring to FIG. 2, which shows an external elevational view of the present invention, and an interface card fixing device 20 depicted in the drawing is primarily assembled from a base 201, a plurality of sets of push rods 205, and a press piece 207 assembled to each end of the push rod 205, wherein a plurality of shaft portions 202 are segmentally formed on one side surface of the base 201, and each of the shaft portions 202 enables a poke rod 203 to be respectively assembled thereto. The poke rod 203 assumes an approximate L-shape, and central position thereof is provided with a relative shaft portion 2031, which is pivotally disposed on the shaft portion 202. A poke portion 2032 is formed at one end of the poke rod 203, and a linkage portion 2033 is formed at the other end. Moreover, a corresponding linkage portion 2041 is formed at one end of a linkage member 204, which takes the form of an approximate inverted L shape, and is pivotal disposed on the corresponding linkage portion 2033 of the poke rod 203, while the other end of the linkage member 204 is pivotal disposed on one end of the push rod 205. Furthermore, another end of the push rod 205 penetrates a though hole 2061 formed in a wall portion 206 of a corresponding side of the base 201, and the end of the push rod 205 is assembled with a press piece 207. A protruding column 2071 is formed on a surface of the press piece 207 to enable a better pressing effect; moreover, the surface can be further assembled with an elastic cushion 2072.

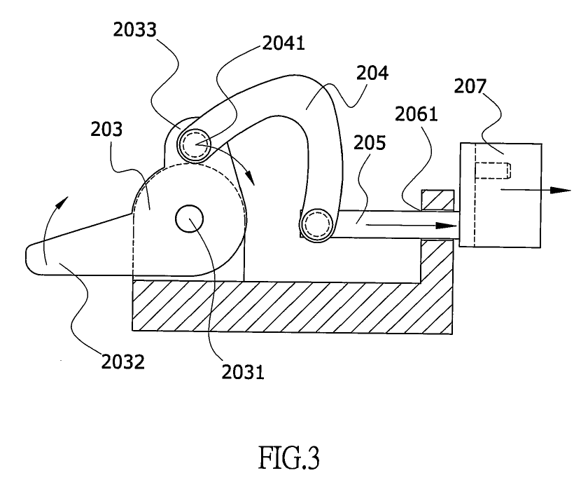

Referring to FIG. 3, which shows a sectional schematic view (1) of the present invention, and as depicted in the drawing, it is clear that when the poke portion 2032 of the poke rod 203 is subjected to a force and made to move, then the relative shaft portion 2031 of the poke rod 203 serves as an actuating central point to enable rotation, at which time, the linkage portion 2033 linked to the corresponding pivotally disposed linkage member 204 actuates the linkage member 204 which pushes the push rod 205, thereby causing rectilinear displacement of the push rod 205 through the through hole 2061 and subject to the limitation thereof, while at the same time, displacement of the push rod 205 is used to cause the end press piece 207 to move in a forward direction. Furthermore, when the poke rod 203 is subjected to a reverse poke, then the push rod 205 is displaced backward, and the press piece 207 is reverse displaced along with it.

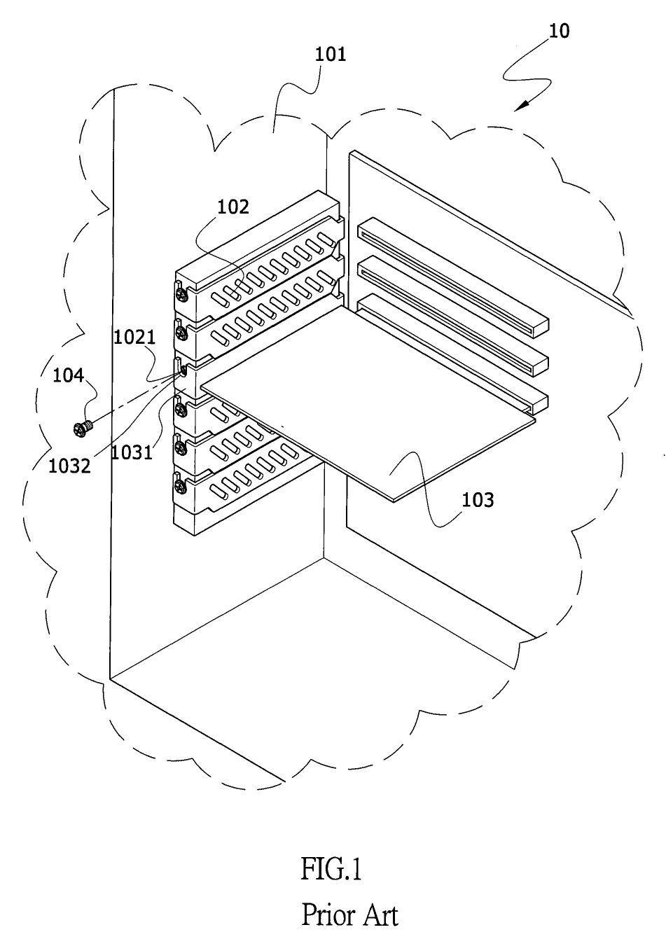

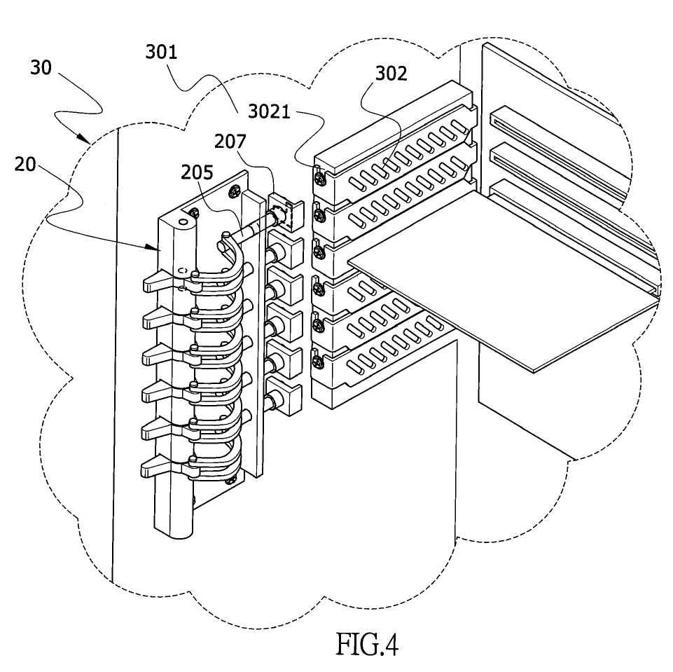

Referring to FIG. 4, which shows an implementation schematic view (1) of the present invention, and as depicted in the drawing, a plurality of sets of interface card installation holes 302 are formed in a rear end of a computer case 301 of a host computer 30, and screw holes, or though holes (not shown in the drawing, refer to the screw holes 1021 of FIG. 1) are formed in side portions 3021 of the sets of interface card installation holes 302. Such a structure is a standard structure for current common computer cases. As depicted in the drawing, the so called interface card fixing device 20 of the present invention is first fixedly located to the case surface close to the side portion 3021 of the set of interface card installation holes 302, and after completing installation, each of the push rods 205 and the press pieces 207 of the interface card fixing device 20 are able to correspond exactly to the side portion 3021 of each respective set of the interface card installation holes 302, which, after completing installation, exhibits the configuration as depicted in the drawing.

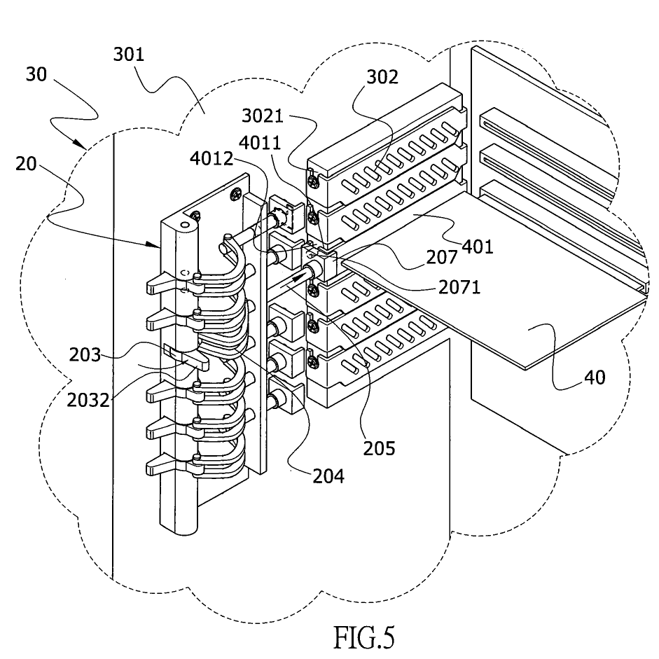

Referring to FIG. 5, which shows an implementation schematic view (2) of the present invention, and as depicted in the drawing, when an interface card 40 is required to be assembled to the set of interface card installation holes 302, then an L-shaped installation piece 401 at an end of the interface card 40 is first made to correspond to one of the sets of interface card installation holes 302, wherein the L-shaped installation piece 401 is of standard specifications, and a U-shaped groove 4012 (or a though hole) is formed in a surface of a bent portion 4011 of the L-shaped installation piece 401. When alignment of the interface card 40 and the set of interface card installation holes 302 is completed, then the U-shaped groove 4012 is made to correspond with the screw hole (not shown in the drawing, refer to the screw holes 1021 of FIG. 1) of the side portion 3021 of the set of interface card installation holes 302. After alignment, the poke rod 203 (that is, the poke portion 2032) of the interface card fixing device 20 is poked using the fingers to cause the linkage member 204 mutually linked and pivotally disposed on the poke rod 203 to further actuate the push rod 205 and push the press piece 207 toward the direction of the L-shaped installation piece 401. When the surface of the L-shaped installation piece 401 has been held down by the press piece 207, then the protruding column 2071 of the press piece 207 exactly penetrates the U-shaped groove 4012 of the L-shaped installation piece 401, and further penetrates the screw hole of the side portion 3021 of the set of interface card installation holes 302. When the press piece 207 is completely tight against the surface of the side portion of the L-shaped installation piece 401, then fixation of the interface card 40 is complete. Furthermore, when requiring disassembly, the poke rod 203 need only be pushed in the reverse direction to cause the push rod 205 to withdraw, and the unclasping operation is complete.

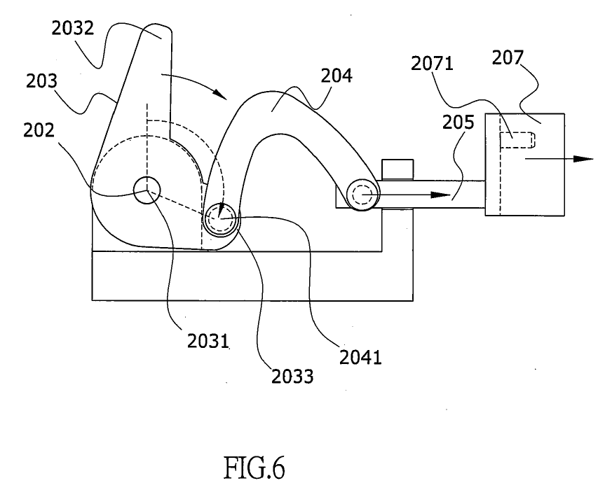

Referring to FIG. 6, which shows a sectional schematic view (2) of the present invention, and as depicted in the drawing, when the poke rod 203 is actuated, circumferential displacement (see the dotted arrow depicted in the drawing) of a peripheral circle of the corresponding linkage portion 2041 at one end of the linkage member 204 is effected along a peripheral circle of the shaft portion 202 (see the dotted line areas depicted in the drawing), which further pushes the push rod 205, thereby pushing the press piece 207 in a forward direction to achieve the effectiveness to hold down the L-shaped installation piece 401 and enable effective fixation of the entire interface card 40 (refer to FIG. 5).

From the above description, the interface card fixing device of the present invention primarily uses a poke rod, which, after linking with a linkage member, forces a push rod in a forward direction, thereby causing a press piece to hold down a L-shaped installation piece assembled at one end of an interface card end, thus enabling rapid securing of the interface card and completing the assembly operation thereof. When disassembling, a reverse force need only be applied to the poke rod to rapidly complete the unclasping operation, and thereby accomplish rapid disassembly of the interface card. Accordingly, based on the embodiments as described above, the present invention indeed is able to achieve the objective of providing an interface card fixing device able to implement fast assembly or disassembly without the assistance of hand tools.

In conclusion, the effectiveness of the present invention to provide new commercial practicability, originality and advancement clearly complies with the essential elements as required for a new patent application, and in accordance with patent law, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An interface card fixing device, installed in a computer case of a host computer, wherein the interface card fixing device enables installation of an interface card to be quickly completed, comprising:
a base, a plurality of shaft portions are formed on one side of the base;
more than one poke rod, each of the poke rods is formed with a relative shaft portion, and the shaft portions enable the poke rods to be mutually linked and pivotally disposed on the shaft portions of the base, one end of each of the poke rods is mutually pivotal disposed on one end of a linkage member;
a push rod, one end of the push rod is pivotally disposed on another end of the linkage member, another end of the push rod penetrates a wall portion of the base; and
a press piece, installed to an end of the push rod.

2. The interface card fixing device according to claim 1, wherein a protruding column is formed on the surface of the press piece.

3. The interface card fixing device according to claim 1, wherein an elastic cushion is installed on the surface of the press piece.

4. The interface card fixing device according to claim 1, wherein a poke portion is formed on one end of the poke rod.

5. The interface card fixing device according to claim 1, wherein more than one though hole is formed in the wall portion of the base, thereby enabling the push rods to penetrate the though holes.

6. The interface card fixing device according to claim 1, wherein a corresponding linkage portion is pivotal disposed between the poke rod and the linkage member, the corresponding linkage portion is able to circumferentially displace along the shaft portion.
